(19) United States
(12) Patent Application Publication
(10) Pub. No.: US 2010/0146058 A1
(43) Pub. Date: Jun. 10, 2010

(54) Method for Providing a Meeting Scheduling Service

(75) Inventor: Michael Naef, Zurich (CH)

Correspondence Address: THE WEBB LAW FIRM, P.C., 700 KOPPERS BUILDING, 436 SEVENTH AVENUE, PITTSBURGH, PA, 15219, US

(73) Assignee: DOODLE AG, Zurich (CH)

(21) Appl. No.: 12/329,967

(22) Filed: Dec. 8, 2008

(51) Int. Cl. G06F 15/16

(52) U.S. Cl. 709/206

(57) ABSTRACT

A system (220) for providing a meeting scheduling service over a network (205) comprises a mail processor (210; 211) to receive an electronic mail request to schedule a meeting from said network (205). A parsing unit (212) parses such a received mail for identifying at least one proposed date and time and at least one participant or organizer (201) for the meeting. A checking unit (207) is connected to the parsing unit (212) and with a secdule database (208) and decides, if the received electronic mail request fulfils the conditions for creation of data field entries in the database (208). Then an email generation and transmittal unit (211) within the mailprocessor (210) either creates and sends an electronic error mail comprising indications relating to missing or erroneous information for poll creation to the identified organizer (201) or creates and sends an electronic confirmation mail to the identified organizer (201) with confirmation of the schedule creation in the database (208) including information for accessing (206, 210) said schedule.

### BACKGROUND OF THE INVENTION

I. Technical Field

The invention relates generally to a scheduling service, particularly to a method for providing a meeting scheduling service and to a method to a polling service.

II. Related Art

The prior art knows several methods and systems for providing scheduling services. One such system is known from U.S. Pat. No. 5,124,912, wherein an apparatus is provided having access to database entries relating to scheduling files for the intended participants and wherein the apparatus has management means to provide at least one common available date and time to schedule a meeting for the intended participants. Said data is then transmitted to the specified invitees using an electronic mail service. It is clear that this proposal is only usable if the apparatus has access to all calendars of the participants of the intended meeting. The preparation of the meeting is done electronically wherein the user chooses the meeting data using fields displayed on screen.

U.S. Pat. No. 7,343,313 relates a method to schedule a meeting using resources, e.g. audio-visual resources, or locations as meeting rooms, that are required for such a meeting. Sending queries to and receiving answers from scheduling agents allow an easier allocation of such resources. However, this only concerns the reservation of such additional means to organize a meeting and does not better support the invitation of participants. The user accesses a meeting scheduling application on its device or on a server and accessed by the user's device.

US 2007/143168 A1 discloses a method and a system of providing a meeting scheduling service for a plurality of users. The aim of the prior art is to suggest a technical solution, when the person who wants to organize a meeting has no access to the calendar data of the people he is willing to invite.

He then has the possibility to provide data on a website and transmit the link to the participants. The meeting scheduling service can be web-based using hypertext mark-up language (HTML) and hypertext transfer protocol (HTTP).

US 2007/143168 also mentions the possibility to transmit the invitation using a telephone (e.g. SMS) and the document mentions that the service can be implemented using e-mail. However, as further disclosure it is only mentioned that the simple mail transfer protocol (SMTP), the post office protocol (POP) or the internet message access protocol (IMAP) could be used without further information on how these technical means can favourably be put into practice.

### SUMMARY OF THE INVENTION

It is an object of the invention to provide to facilitate the generation of the meeting data. The invention is based on the insight that all proposals of the prior art require—in the case of server-based preparation—a long online time or—in the case of scheduling application—use of a device where this application is usable to prepare the data entries for a query.

It is a further object of the invention to provide a platform-independent solution for such meeting scheduling service.

A system for providing a meeting scheduling service over a network according to the invention comprises a mail processor to receive an electronic mail request to schedule a meeting from said network. A parsing unit parses such a received mail for identifying at least one proposed date and time and at least one participant or organizer for the meeting. A checking unit is connected to the parsing unit and with a secdule database and decides, if the received electronic mail request fulfils the conditions for creation of data field entries in the database. Then an email generation and transmittal unit within the mailprocessor either creates and sends an electronic error mail comprising indications relating to missing or erroneous information for poll creation to the identified organizer or creates and sends an electronic confirmation mail to the identified organizer with confirmation of the schedule creation in the database including information for accessing said schedule.

### SHORT DESCRIPTION OF THE DRAWINGS

The invention is now described in relation to the accompanying drawings, where like reference numerals refer to identical of functionally similar features throughout all Figures, which show:

FIG. 1 a schematic view of a flow chart of a method according to an embodiment according to the invention,

FIG. 2 a schematic view of an additional flow chart of an optional workflow according to the invention, and

FIG. 3 a block diagram of a system according to an embodiment according to the invention in an application context.

### DETAILED DESCRIPTION OF PREFERRED EMBODIMENTS

The present disclosure concerns a method for providing a meeting scheduling service, which method can also be used for providing a polling service. The scheduling service itself comprises a database comprising data sets for each scheduled meeting or poll. The data sets can be accessed by the relevant persons through a rights management. The access can be organized through a web interface wherein a secret URL is known to all persons concerned. These persons are named organizer and invitees.

One database set for a meeting or query comprises upon creation:
contact information relating to the organizer, e.g. a character field of defined length for an e-mail address or a telephone number for SMS transfers
short title relating to the scheduled meeting or poll, e.g. a character field of defined length
data fields for the options of the schedule, which can comprise date, including day of the week, day, week, month, year, starting hour, ending hour, duration for a meeting, and which can comprise possible answers as yes, no, if need be, or character fields for more advanced options

All data fields are connected, either upon creation or later during the poll, with a decision field for each invitee. The decision field preferably has a logical value, but it is also possible to allow numerical values.

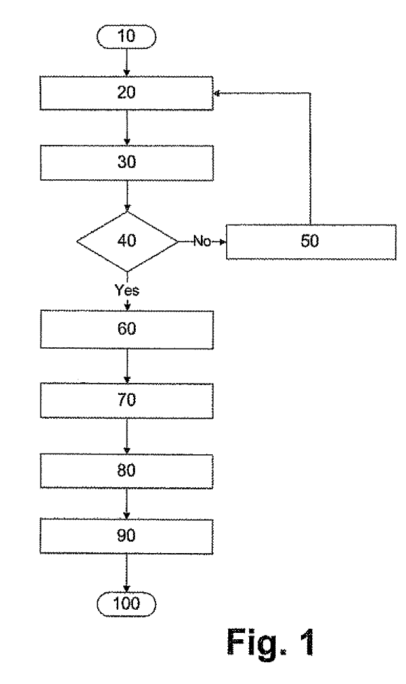

FIG. 1 shows a schematic view of a flow chart of a method according to an embodiment according to the invention.

The start 10 relates to the initialization of the method, e.g. starting an e-mail application. Then, in block 20, the organizer prepares an e-mail comprising the poll request and having a designated format. The designated format is explained in connection with the parsing of the e-mail in the next block 30.

The e-mail is sent by the organizer to the dedicated address and is analyzed in the parsing step 30.

The parsing takes both the e-mail header and the e-mail body into account. The parsing verifies the e-mail's syntax and determines the e-mail's semantics. The parsing also makes sure to prevent mail loops, floods, and other by problems by analyzing the appropriate headers for mailing lists and noreply senders, by setting a header which can be recognized in mails being resent in mail loops, and by implementing flood control, i.e., counting and limiting the number of mails sent to a specific address.

To aid the parsing, the e-mail may contain reserved words, wherein the term “word” comprises entire words as “starting hour” or “from” and “to” and special characters to identify comments or command lines.

The parsing comprises the allocation of values read from the e-mail to different temporary variables according to the parsing conditions.

The e-mail header provides the following pieces of information: The “to:” field of the e-mail comprises a dedicated e-mail address of the schedule service computer 220. It is obvious that this dedicated e-mail address is a prerequisite for the method, since otherwise the e-mail will not arrive at the service computer.

The “from:” field of the e-mail is used as the organizer's address unless there is a different “reply-to” address, which can be used instead.

Of course, if the information were transmitted by SMS, then the address would be the (cellular) phone number of the organizer and the SMS server number of the meeting schedule service computer.

The “subject” field of the e-mail is used as the meeting's or the poll's subject or short title.

The e-mail body must contain one or more options to be voted on and can contain poll parameters: Data fields for the options of the schedule, which can comprise date, including day of the week, day, week, month, year, starting hour, ending hour, duration for a meeting, are interpreted either in any subsequent line or in any subsequent line having a special character as a dash (“-”). Each such line is considered a meeting proposal line, if a complete interval in time or point in time can be extracted from such a line.

The organizer's locale (i.e., language and locality) is useful for a number of reasons: to set the preferred user interface language, to determine the organizer's timezone, to assist the parsing process when having to parse ambiguous dates (see below), etc. The locale can be determined in a number of ways: a) using a special suffix to the e-mail address (e.g., init+en-us@ . . . ), b) geo-locating the sending hosts IP address (included in the mail header), c) using locale information from the emails “Content-Language” header, where present.

The parsing process tries to be as user-friendly as possible by assuming reasonable values whenever necessary information is missing. E.g., a simple weekday name (Mon, Tue, Wed, . . . ) is interpreted as the next possible weekday. A simple date of month indication (3^{rd}, 21^{st}, . . . ) is interpreted as that respective date in the current month (if the current date is earlier) or in the subsequent month. If the day of month and the month are both given (Apr 21, Aug 2, . . . ), it is interpreted as the next possible such date (i.e., in the current year, or in the subsequent year). A user can of course also fully specify the date (Apr. 12, 2008, Dec. 1, 2010, . . . ). In all these variants, the parsing process is also as user-friendly as possible by accepting various ways they might be input by the user (e.g., monday, Mon, mon, . . . or Apr. 22, 2010, 2010-04-22, 20100422, 22 Apr. 2010, 22/4/2010, . . . ). Of course, parsing calendar dates without alphanumerical information can sometimes be ambiguous: as 11-12-2008 may be interpreted as 11-Dec or 12-Nov, which are in September 2008 both possible options for a meeting. In such cases, the locale information (derived from the e-mail, see above) can be used to determine which format might be the one intended by the organizer.

Every line which does not allow an allocation of a complete interval in time or point in time, is not considered a meeting proposal line and used as comment line. It is possible to align more than one time interval in one line, e.g. “Wednesday, 11-12, 1630-1730”.

It is possible to use special keywords or characters to select special options for the meeting. E.g., a line starting with “#hidden” could denote a meeting proposal in which the invitees' answers are not made visible to other invitees but only to the organizer.

White space should not matter in the whole parsing process as e-mail systems sometimes add whitespace (e.g., line breaks) where the user did not put one.

Upon completion of the parsing process, the schedule service computer checks in the checking step 40 the temporary data structure.

This comprises the generation of an answer e-mail to the organizer of the poll, wherein the content of the e-mail depends on the result of the checking step 40.

If there is no single meeting proposal line, i.e. one valid recognized meeting time interval or point in time, then the entire mail is returned with indications relating to the parsing language. If there is at least one meeting proposal line, but there are errors or unclear information in such a line, e.g. 10-Nov-2008 07-09, wherein it is not clear if it is 07 am to 09 am or 07 pm to 09 pm, then the parsed email can be returned with the mention of both options and the instructions to delete unnecessary lines.

Therefore, if the result of the checking step 40 is no, then an error message is generated 50 and sent to the organizer. Of course the semi-parsed part of the error message can be used for an updated poll message 20.

If the result of the checking step 40 is yes, then a poll is generated by the schedule service computer in step 60. This relates to the entry of all information extracted and parsed from the e-mail and stored, into the schedule database.

If the organizer has a personal account, then the new poll is associated with the organizer's account in an association step 70. The organizer's account can be identified by the e-mail address as used or using a digital signature.

As mentioned above, the schedule service computer creates an e-mail in the case of an error. A similar e-mail is created in information step 80, wherein the successful data entries of the meeting proposal lines are provided for the main body of the e-mail with all additional information. Especially it is possible to include a link in the e-mail allowing any person (or any registered person) to access the scheduled meeting poll and this information is transmitted in an e-mail to the organizer. The URL link can also be considered as a schedule-ID to access the specific poll.

The e-mail comprising the link can then be sent by the organizer to the invitees in transmittal step 90, to allow the invitees to access the meeting schedule online, before closing 100 the mail-program by the organizer.

In case that the organizer includes e-mail addresses (or SMS related addresses) of the invitees in the set-up e-mail in step 20 (by using the aforementioned special characters), then the schedule service computer can use these addresses to directly send the link and the mail to the invitees.

In an additional embodiment the invitee has then the choice to access the web-site or to answer the email to the schedule computer deleting entire meeting proposal lines or time intervals on such line, which does not fit for his personal calendar. Beside deleting and resending the remaining lines to the schedule computer, it is also possible that any lines start with a “−” and that the invitee has to change the first character of lines with convenient meeting conditions into “+”, or all lines start with a “+” and this can/should be switched into “−” for impossible meeting conditions for a specific invitee. Of course, it is possible to use special characters other than “+” and “−” to achieve this functionality. Note that the invitee needs to make sure that the poll ID, which was sent with the e-mail, needs to remain in the e-mail in order to enable the schedule service to associate the invitee's answer with the poll.

The workflow in FIG. 1 can be summarized according to an embodiment similar to the embodiment of FIG. 1 of the invention as follows:

| | |
|---|---|
| 10 | Start |
| 20 | Organizer sends e-mail with poll request to a designated |
| | e-mail address at scheduling service |
| 30 | Scheduling service receives e-mail, extracts the necessary |
| | information and verifies its format |
| 40 | Is the e-mail's format correct? |
| 50 | Scheduling service sends an error message to the e-mail's |
| | sender |
| 60 | Scheduling service analyzes the e-mail to extract the |
| | necessary information to set up a poll |
| 70 | Scheduling service creates the poll based on the extracted |
| | information |
| 80 | Scheduling service sends e-mail to the organizer confirming |
| | that the poll was created successfully and including |
| | a link to the poll |
| 90 | Organizer forwards the link to the participants |
| 100 | End |

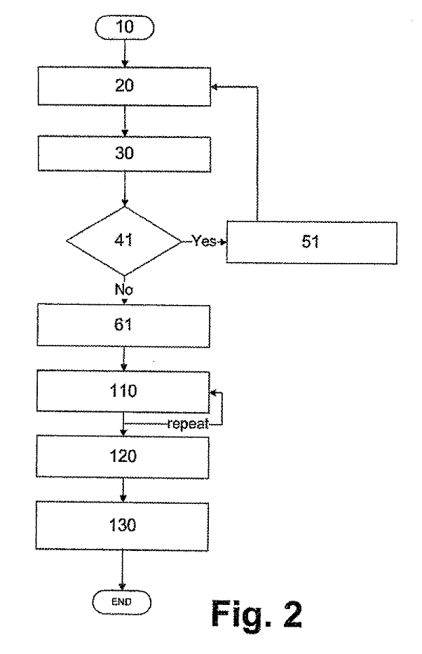

FIG. 2 shows a schematic view of an additional flow chart of an optional workflow which can be used in addition to the first workflow at the organizer's discretion. Here, we assume that the organizer has set up a poll (e.g., using the first workflow described above) and starts his mail client 10. The organizer then wishes to send the link to the poll to the invitees. He does so by sending an e-mail containing the link to the poll to all the invitees, and he adds a designated e-mail address to the e-mail's “to”, “cc”, or “bcc” fields 20.

The checking step 41 now relates to the check of the poll ID, e.g. the UR-link mentioned in connection with FIG. 1 and generates an error message 51, if the poll-ID is not existing, the e-mail is not related to the organizer's information or the information in the mail body relating to the meeting proposal lines are not correct.

Additionally the mail body can comprise reminder information as 1 d, 3 d or 2 w for one day, three days or 2 weeks before the first possible meeting or calculated from the date of the e-mall. If no information is given, the service assumes a default value like 2 d. It is also possible that a dedicated address for reminders is provided to the service schedule computer as an e-mail address like “remindme+2 d@” or something similar.

In this context it is preferable that the e-mail addresses of the invitees are known or included in the e-mail (either in the “to” or “cc” header fields or using special command characters in the e-mail), so that said reminders can be sent to all invitees. The organizer can specify this by using an address like “remindthem@”. Otherwise the reminder is only sent to the organizer and he has to check the current situation. To this end, the organizer uses an address like “remindme@”.

In a poll updating step 61 the information from the e-mail generating step 20 is stored with the existing poll as identified using the poll's id given in the e-mail. After the initial transmittal of confirmation information as in FIG. 1 the schedule service remains inactive 110 for the specified period in time. The electronic confirmation mail, as well as a possible error mail, can comprise the correctly parsed information, especially according to ASCII standard.

After lapse of the time the reminder schedule service 120 repeats the step 110, i.e. sends a reminder to the organizer and/or the invitees.

A closing step 130 is available, wherein the organizer can stop the reminder routine through deleting the poll or setting a corresponding non-reminder flag.

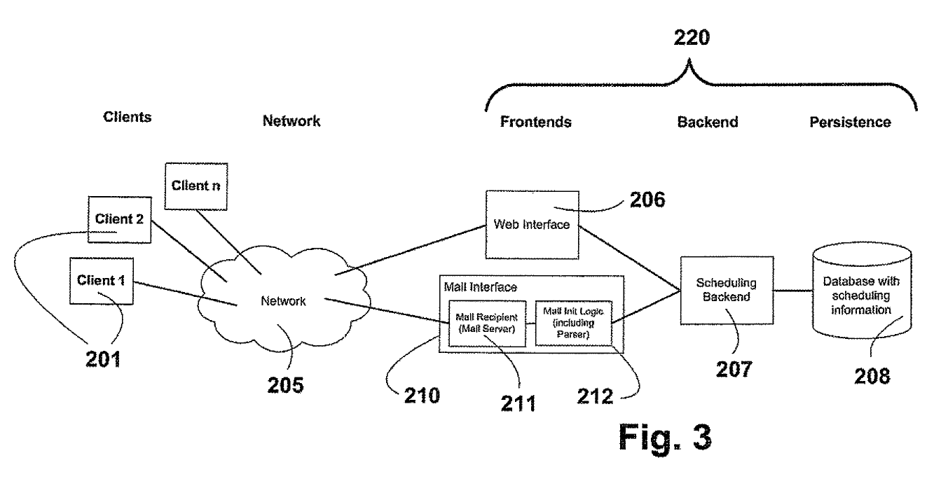

FIG. 3 shows a block diagram of a system according to an embodiment according to the invention a block diagram in an application context.

Client 1 to Client n, having the reference numerals 201 are connected to a network 205, e.g. the internet, but in principle the network 205 can be any network allowing a mail based information exchange. According to the prior art, the network 205 has to allow using a so called web application to connect to a web interface 206 of a schedule service computer 220. The web interface 206 is also connected to the network 205 and is provided to allow clients 201 to access the frontend application 206 to request the set-up of a meeting through entering relevant data for such a meeting. Such information is forwarded by the web interface 206 to the connected scheduling application 207, also named scheduling backend of the schedule service computer 220. The scheduling application 207 extracts the data from the client's 201 entries on the web interface 206 and stores said data in the database 208 of the schedule service computer 220. The database 208 comprises a plurality of data sets of scheduling information. The web interface 206 is also provided for being connected by further clients 201 modifying initial or modified database entries for a given meeting. Such changes can comprise the entry of data relating to an intended participation to such a meeting, the entry of comments or deletion or modification of these entries. As mentioned above, these manipulations necessitate a prolonged online time and the possibility to visualize the web interface on a corresponding screen.

The invention introduces the mail interface 210, being also connected to the network 205 and to the scheduling backend 207. The connection to the network can be of any kind allowing the mail interface to send and to receive electronic mails also called emails or simply mails. Electronic mail is the exchange of computer-stored messages by telecommunication and is one of the protocols included with the Transport Control Protocol/Internet Protocol (TCP/IP) suite of protocols. A well known protocol in the prior art for sending electronic mail is the Simple Mail Transfer Protocol (SMTP) and a protocol for receiving electronic mail is POP3. Electronic mail messages are usually encoded in ASCII text and the embodiment described in this context is ASCII-based. The mail server 211 comprises the applications necessary to send and to receive electronic mail.

The mail interface 211 also comprises a mail logic 212 including a parser. The electronic mail logic 212 with its parser comprises modules allowing to perform the checking step 40 and 41, the module for preparation of an error message 50 or 51, the transferral of the extracted information to the scheduling backend 207 for further action.

It is preferred, that the backend 207 is a separate unit since the backend 207 can be used for several frontends 206 and 210 as shown in the drawings. It is a further advantage in this context that the same poll can be handled using different frontends, e.g. the scheduled meeting can be initialised via the mail interface 210 wherein subsequent decisions of the intended users can be done using the web interface.

Since the parsed information is transmitted to the backend 207 with the indication, being a flag, that the information entered in the mail interface 210 and was not entered in the web interface 206, the method comprises the step to prepare an answer and to send an electronic error mail or an electronic confirmation mail via the mail interface 210 instead of the display of the information relating to the stored meeting information on the web interface.

Providing the mail interface 210 allows a more flexible and secure service for the users.

In this respect the mail interface 210, having two sub-units can also be separated in the sense that the parser within the mail init logic 212 can also be separated from the mail interface 210 itself, since the parser could then be used for different input formats as mail, SMS, instant messaging etc. . . .

The interface between frontend 106, 120 and backend 207 can use a protocol as RESTful API, e.g. a system using representational state transfer (REST) being a style of software architecture for distributed hypermedia systems.

### REFERENCE NUMERALS

10 start
20 mail preparation
30 transmittal of the mail
40 checking step
41 checking step
50 error message preparation
51 error message preparation
60 poll generation step
60 poll updating step
70 association step
80 information step
90 transmittal step
100 end
110 inactive schedule service
120 reminder schedule service
130 closing step
201 client 1, 2, . . . n
205 network
206 web interface
207 scheduling backend
208 database
210 mail interface
211 mail server
212 mail logic including parser
220 schedule service computer

1. A method for providing a scheduling service, comprising:
providing an electronic mail body comprising at least one proposed time interval or point in time for the meeting or poll and at least one participant as organizer for the meeting;
transmitting the electronic request mail as request to a schedule service computer;
receiving said request to schedule a meeting at the schedule service computer,
parsing the electronic mail to extract at least one time interval or point in time for the meeting and at least one participant for the meeting;
checking said extracted information, if there is at least one time interval or point in time for the meeting, wherein the method comprises the alternative steps
sending an electronic error mail comprising indications relating to the missing or erroneous time interval information, point in time information or further information for poll creation to the identified organizer, or
sending an electronic confirmation mail to the identified organizer with confirmation of the schedule creation in the database including information for accessing said schedule.

2. The method according to claim 1, wherein the information for accessing said schedule comprises a web URL.

3. The method according to claim 1, wherein the electronic mail after the checking step comprises the correctly parsed information in the error mail and/or the confirmation mail.

4. The method according to claim 1, wherein, if the electronic request mail comprises information relating to the electronic mail address of at least one invitee, the electronic confirmation mail is sent to this or these electronic mail address(es).

5. The method according to claim 4, wherein the schedule system accepts electronic mail answer on confirmation mails receiving meeting related information in the form of acceptance or refusal.

6. The method according to claim 4, wherein the schedule system database comprises reminder data fields to resend confirmation mails after lapse of time according to a reminder data field.

7. The method according to claim 6, wherein the schedule system database resend confirmation mails indicating intermediately received meeting information from answers on confirmation mails; wherein the order of meeting proposal lines is following the preferred best date and time for the meeting.

8. A system for providing a meeting scheduling service over a network, comprising:
a mail processor to receive an electronic mail request to schedule a meeting from said network,
a parsing unit connected to the mail processor for parsing a received electronic mail request for identifying at least one proposed date and time for the meeting, and at least one participant or organizer for the meeting,
a schedule database for storage of data field entries of scheduled meeting sets,
a checking unit connected to the parsing unit and with the secdule database for deciding, if the received electronic mail request fulfils the conditions for creation of data field entries in the schedule database,
an email generation and transmittal unit within the mailprocessor adapted to create and send an electronic error mail comprising indications relating to missing or erroneous information for poll creation to the identified organizer, and adapted to create and send an electronic confirmation mail to the identified organizer with confirmation of the schedule creation in the database including information for accessing said schedule.

9. A computer readable medium storing instructions for performing a method for providing a meeting scheduling service, wherein the instructions for performing said method comprise the steps:
providing an electronic mail body comprising at least one proposed time interval or point in time for the meeting or poll and at least one participant as organizer for the meeting;
transmitting the electronic request mail as request to a schedule service computer;
receiving said request to schedule a meeting at the schedule service computer,
parsing the electronic mail to extract at least one time interval or point in time for the meeting and at least one participant for the meeting;
checking said extracted information, if there is at least one time interval or point in time for the meeting, wherein the method comprises the alternative steps
sending an electronic error mail comprising indications relating to the missing or erroneous time interval information, point in time information or further information for poll creation to the identified organizer, or
sending an electronic confirmation mail to the identified organizer with confirmation of the schedule creation in the database including information for accessing said schedule.
